(19) United States
(12) Patent Application Publication
(10) Pub. No.: US 2010/0101925 A1
(43) Pub. Date: Apr. 29, 2010

(54) Reset Button Structure

(75) Inventors: Ling-Jun Tao, Shanghai City (CN); Jackie Wang, Shanghai City (CN)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: INVENTEC APPLIANCES CORP., Taipei Hsien (TW)

(21) Appl. No.: 12/604,598

(22) Filed: Oct. 23, 2009

(30) Foreign Application Priority Data
Oct. 27, 2008 (TW) 97219151

(51) Int. Cl. H01H 13/70

(52) U.S. Cl. 200/345

(57) ABSTRACT

A reset button structure is described, wherein the reset button structure is disposed in a case. The reset button structure comprises: a sheath disposed on the case, wherein the sheath contains a positioning hole, and at least one side hole on a side of the sheath and connecting with the positioning hole, and the positioning hole comprises an opening on a surface of the case; and a reset shaft inserted into the positioning hole, wherein a side of the reset shaft includes at least one protrusion located in the side hole, and the protrusion is movable in a movement path in the side hole.

### RELATED APPLICATIONS

This application claims priority to Taiwan Application Serial Number 97219151, filed Oct. 27, 2008, which is herein incorporated by reference.

### FIELD OF THE INVENTION

The present invention relates to a button structure, and more particularly to a reset button structure.

### BACKGROUND OF THE INVENTION

Typical electronic devices, such as computers, music players, game players, internet protocol (IP) routers etc. are generally equipped with reset buttons, so that users can make a part of or all data processors return to predetermined states by pushing the reset button when the operation of the electronic devices is out of order, for example, when the electronic devices crash.

The current reset button devices have some poor designs, so that some problems are generated when the reset button devices are in use. For example, a reset shaft of each reset button device usually cannot be effectively fastened in a positioning hole of the case of the electronic device, so that after assembly, the reset shaft still substantially moves, rotates or axially deflects in the positioning hole. As a result, when the reset button devices are in use, the reset buttons are often jammed to cause the reset buttons to be inactive.

According with the aforementioned description, a reset button structure with high stability and reliability is need.

### SUMMARY OF THE INVENTION

Therefore, one aspect of the present invention is to provide a reset button structure, in which a reset shaft has at least one protrusion, and a hollow sheath of a case has a corresponding side hole, so that with the protrusion and the corresponding side hole, the reset shaft can be stably installed in the sheath, and will not rotate randomly and will not come off the sheath, thereby greatly enhancing the reliability and the stability of the reset button.

Another aspect of the present invention is to provide a reset button structure, in which a protrusion of a reset shaft only can move in a path preset in a side hole on a side of a sheath, and a gap between the reset shaft and a positioning hole of the sheath is narrow, so that the axial orientation of the reset shaft can be strengthened to prevent the reset shaft from being jammed and inactive due to the deviation of the reset shaft during the operation.

According to the aforementioned aspects, the present invention provides a reset button structure disposed in a case, and the reset button structure comprises: a sheath disposed on the case, wherein the sheath contains a positioning hole, and at least one side hole on a side of the sheath, said at least one side hole connects with the positioning hole, and the positioning hole comprises an opening on a surface of the case; and a reset shaft inserted into the positioning hole, wherein a side of the reset shaft includes at least one protrusion located in the side hole, and the protrusion is movable in a movement path in the side hole.

According to a preferred embodiment of the present invention, the vertical cross-sectional view of the protrusion resembles an inverted triangle.

According to another preferred embodiment of the present invention, the movement path of the protrusion in the side hole is substantially 1 mm.

According to further another preferred embodiment of the present invention, when the reset shaft is located in the positioning hole, the gap between the reset shaft and the sheath has a width between substantially 0.2 mm and substantially 0.3 mm.

### BRIEF DESCRIPTION OF THE DRAWINGS

FIG. 1 illustrates an assembly diagram of a reset button structure in accordance with a preferred embodiment of the present invention;

FIG. 2 is a cross-sectional view of a reset button structure in accordance with a preferred embodiment of the present invention;

FIG. 3 is a three-dimensional diagram of a reset button structure in accordance with a preferred embodiment of the present invention; and

FIG. 4 is a side view of a reset button structure in accordance with a preferred embodiment of the present invention.

### DETAILED DESCRIPTION OF THE PREFERRED EMBODIMENT

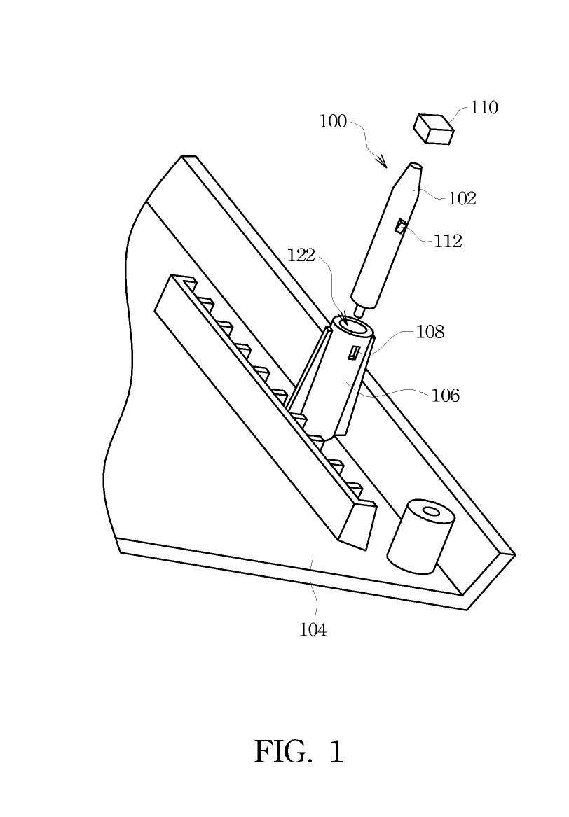

The present invention discloses a reset button structure having superior stability and reliability. In order to make the illustration of the present invention more explicit, the following description is stated with reference to FIG. 1 through FIG. 4.

Refer to FIG. 1. FIG. 1 illustrates an assembly diagram of a reset button structure in accordance with a preferred embodiment of the present invention. A reset button structure 100 is typically disposed in a case 104 of an electronic device, such as a computer, a personal digital assistant (PDA), a mobile phone, a music player, a game player, an internet protocol router or any other type of electronic device. When the operation of an electronic device is bad or out of order, a user can make some or all data processing devices return to predetermined states by pushing the reset button structure 100.

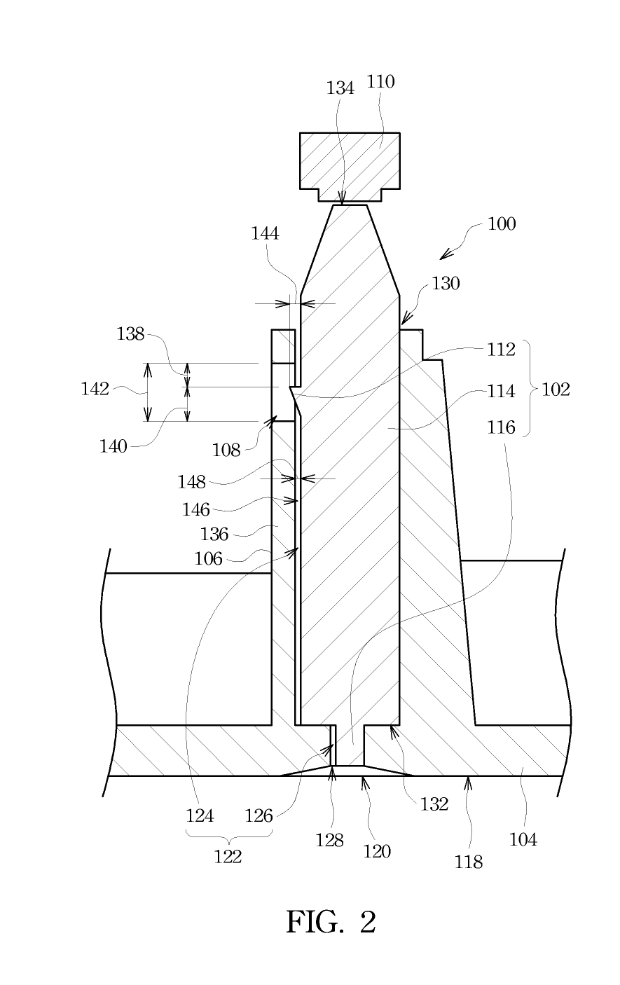

In an exemplary embodiment, the reset button structure 100 comprises a sheath 106 and a reset shaft 102. FIG. 2 is a cross-sectional view of a reset button structure in accordance with a preferred embodiment of the present invention. With reference to FIG. 2, the sheath 106 is disposed on the case 104, wherein the sheath 106 and the case 104 may be made as an integral structure by injection molding. The sheath 106 contains a positioning hole 122, wherein the positioning hole 122 axially passes in the sheath 106. Two openings 128 and 130 of the positioning hole 122 are respectively located on two opposite sides of the sheath 106, wherein the opening 128 of the positioning hole 122 is located on a surface 118 of the case 104. In another preferred embodiment, the surface 118 of the case 104 may have an indentation 120, and the opening 128 of the positioning hole 122 is located in the indentation 120. In an embodiment, the surface 118 of the case 104 may be a side surface, a top surface or a bottom surface of the case 104. In the present exemplary embodiment, such as shown in FIG. 1 and FIG. 2, the surface 118 is the bottom surface of the case 104 of the electronic device. According to the structural shape of the reset shaft 102 to be inserted into the sheath 106, the positioning hole 122 contained by the sheath 106 may comprise a first hole 124 and a second hole 126 with different diameters, wherein the first hole 124 is located over the second hole 126, the first hole 124 connects with the second hole 126, and the diameter of the first hole 124 is greater than that of the second hole 126.

A side 136 of the sheath 106 has at least one side hole 108, wherein the side hole 108 is preferably set at a position on the side 136 nearer to the opening 130, and the side hole 108 connects with the positioning hole 122. In the present exemplary embodiment, the side hole 108 penetrates the side 136 of the sheath 106. In another embodiment, the side hole 108 may be a sunken hole set on the side 136 and connecting with the positioning hole 122, but does not really perforate the side 136 of the sheath 106.

The reset shaft 102 is inserted into the positioning hole 122 of the sheath 106, wherein the reset shaft 102 comprises at least one protrusion 112, and the protrusion 112 is set on a side of the reset shaft 102. In the present invention, the number of the protrusions 112 on the side of the reset shaft 102 is preferably the same as that of the side holes 108 of the sheath 106, and the locations of the protrusions 112 also need to match those of the side holes 108 of the sheath 106. The protrusion 112 of the reset shaft 102 may be a three-dimensional structure, such as a triangular pyramid, a hemisphere or an arc or a curved body, and is preferably an inverted triangular pyramid. Therefore, a vertical cross-sectional view of the protrusion 112 of the reset shaft 102 may resemble a triangle, a semicircle or an arc, and preferably resembles an inverted triangle, such as shown in FIG. 2.

In an exemplary embodiment, such as shown in FIG. 2, the reset shaft 102 may further comprise a body 114 and a head 116, wherein the protrusion 112 is set on a side of the body 114, and the head 116 is disposed on one end 132 of the body 114. Simultaneously referring to FIG. 1 and FIG. 2, when the reset shaft 102 is installed, the reset shaft 102 is inserted into the positioning hole 122 of the sheath 106 in a direction from the opening 130 at one end of the positioning hole 122 to the opening 128 at the other end of the positioning hole 122, to make the protrusion 112 of the reset shaft 102 be wedged or restricted into the side hole 108 set on the inner surface of the sheath 106 and to make the body 114 and the head 116 of the reset shaft 102 be respectively located in the first hole 124 and the second hole 126 of the positioning hole 122. With the reset shaft 102 being wedged into the side hole 108, and since the diameter of the underlying second hole 126 is smaller than that of the first hole 124, the reset shaft 102 can substantially stick in the positioning hole 122 of the sheath 106. After the reset shaft 102 substantially sticks in the positioning hole 122 of the sheath 106, the head 116 is located in the opening 128 of the positioning hole 122 as shown in FIG. 2. In a preferred embodiment, the head 116 is located in the indentation 120 in the surface 118 of the case 104 and does not protrude beyond the surface 118 of the case 104. This condition can help prevent the reset shaft 102 from being touched or pushed accidentally when it sticks out beyond the surface 118, and therefore can prevent the reset function from being accidentally performed.

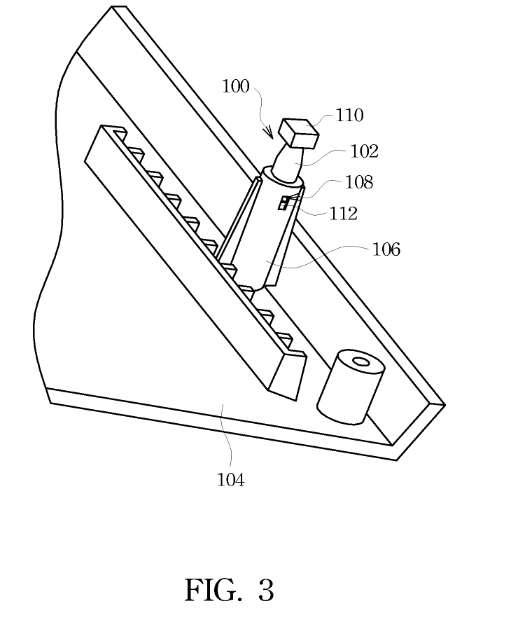

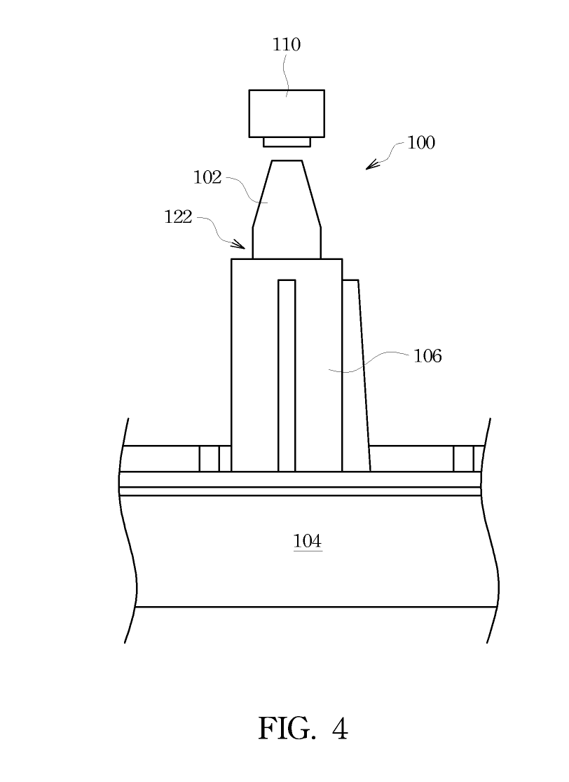

As shown in the three-dimensional diagram of FIG. 3 and the side view of FIG. 4, after the assembly of the reset shaft 102 and the sheath 106 is completed, the other end 134 of the body 114 of the reset shaft 102 opposite to the head 116 protrudes beyond the sheath 106. A switch button 110 of the electronic device for the reset function may be disposed to correspond to the end 134 of the body 114 of the reset shaft 102. A gap may exist between the switch button 110 and the end 134 of the body 114, such as shown in FIG. 2.

In the present invention, a height 140 of the protrusion 112 of the reset shaft 102 is smaller than a height 142 of the side hole 108 of the sheath 106, and this leaves leeway to the protrusion 112, allowing it to move in a movement path in the side hole 108 of the sheath 106, wherein the movement path can be represented by a movement distance 138 of the protrusion 112 in the side hole 108. The protrusion 112 is movable in the movement path. In an exemplary embodiment, the movement distance 138 may be substantially equal to 1 mm. In an embodiment, the gap between the switch button 110 and the end 134 of the body 114 is less than the movement distance 138 of the protrusion 112 in the side hole 108. In addition, when the reset shaft 102 is located in the positioning hole 122 of the sheath 106, the gap 146 between the body 114 of the reset shaft 102 and the sheath 106 has a width 148 preferably less than a thickness 144 of the protrusion 112 to effectively fasten the reset shaft 102 in the positioning hole 122 of the sheath 106 and to prevent the reset shaft 102 from slipping or coming off the sheath 106. In an exemplary embodiment, when the reset shaft 102 is located in the positioning hole 122 of the sheath 106, the width 148 of the gap 146 between the body 114 of the reset shaft 102 and the sheath 106 is preferably between substantially 0.2 mm and substantially 0.3 mm.

In the present invention, since a side of the reset shaft 102 has the protrusion 112, and the side 136 of the positioning hole 122 of the sheath 106 has the corresponding side hole 108, after the reset shaft 102 is inserted into the positioning hole 122 of the sheath 106, the protrusion 112 can be wedged into the side hole 108 to form an upended hook structure. With the design of the upended hook structure, the reset shaft 102 can be axially fastened, and cannot normally be pulled out in a reverse direction, and further the reset shaft 102 cannot freely rotate around a longitudinal axis of the reset button structure 100, thereby achieving the object of effectively fastening the reset shaft 102.

When a user wants to reset an electronic device with the reset button structure 100, the user can press the head 116 of the reset button structure 102 toward and against the switch button 110, moving the body 114 and thus the protrusion 112 of the reset shaft 102 in the movement path represented by the movement distance 138 in the side hole 108 of the sheath 106. Since the gap between the switch button 110 and the end 134 of the body 114 is smaller than the movement distance 138 of the protrusion 112 in the side hole 108, when the head 116 on the other end 132 of the body 114 is pushed, the end 134 of the body 114 can push the switch button 110 to perform or start the reset function of the electronic device. When the reset operation is performed, the switch button 110 springs back to push the body 114 toward the opening 128 of the positioning hole 128 of the sheath 106, making the reset shaft 102 return to the original position.

In view of the aforementioned embodiments of the present invention, one advantage of the present invention is that a reset shaft of the reset button structure of the present invention has at least one protrusion, and a hollow sheath of a case has a corresponding side hole, so that with the protrusion and the corresponding side hole, the reset shaft can be stably installed in the sheath, and will not rotate freely and slip or come off the sheath, thereby greatly enhancing the reliability and the stability of the reset button.

In view of the aforementioned embodiments of the present invention, another advantage of the present invention is that a protrusion of a reset shaft of the reset button structure of the present invention after installation can move only in a movement path preset in a side hole on a side of a sheath, and a gap between the reset shaft and the sheath is narrow, so that the longitudinally axialwise fastening of the reset shaft can be strengthened to prevent the reset button from ceasing to be effective when pushed due to loose deviation of the reset shaft during operation.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A reset button structure disposed in a case and comprising:
a sheath disposed on the case, wherein the sheath contains a positioning hole, and at least one side hole on a side of the sheath, said at least one side hole connects with the positioning hole, and the positioning hole comprises an opening on a surface of the case; and
a reset shaft inserted into the positioning hole, wherein a side of the reset shaft includes at least one protrusion located in the side hole, and the protrusion is movable in a movement path in the side hole.

2. The reset button structure according to claim 1, wherein the side hole penetrates the side of the sheath.

3. The reset button structure according to claim 1, wherein the sheath and the case are made as an integral structure.

4. The reset button structure according to claim 1, wherein a vertical cross-sectional view of the protrusion resembles an inverted triangle.

5. The reset button structure according to claim 1, wherein a vertical cross-sectional view of the protrusion resembles a semicircle.

6. The reset button structure according to claim 1, wherein a vertical cross-sectional view of the protrusion resembles an arc.

7. The reset button structure according to claim 1, wherein the movement path is substantially equal to 1 mm.

8. The reset button structure according to claim 1, wherein when the reset shaft is located in the positioning hole, a gap between the reset shaft and the sheath has a width less than a thickness of the protrusion.

9. The reset button structure according to claim 1, wherein when the reset shaft is located in the positioning hole, a gap between the reset shaft and the sheath has a width between substantially 0.2 mm and substantially 0.3 mM.

10. The reset button structure according to claim 1, wherein the surface of the case has an indentation, and the opening of the positioning hole is located in the indentation.

11. The reset button structure according to claim 1, wherein the surface of the case is a bottom surface of the case.

12. The reset button structure according to claim 1, wherein one end of the reset shaft comprises a head located in the opening.

13. A reset button structure disposed in a case and comprising:
a sheath disposed on the case, wherein the sheath contains a positioning hole, and at least one side hole on a side of the sheath, said at least one side hole connects with the positioning hole, and the positioning hole comprises an opening on a surface of the case; and
a reset shaft inserted into the positioning hole, wherein the reset shaft comprises:
a body;
at least one protrusion on a side of the body and located in the side hole, wherein the protrusion is movable in a movement path in the side hole; and
a head on one end of the body and located in the opening.

14. The reset button structure according to claim 13, wherein the side hole penetrates the side of the sheath.

15. The reset button structure according to claim 13, wherein the sheath and the case are made as an integral structure.

16. The reset button structure according to claim 13, wherein a vertical cross-sectional view of the protrusion resembles an inverted triangle.

17. The reset button structure according to claim 13, wherein a vertical cross-sectional view of the protrusion resembles a semicircle.

18. The reset button structure according to claim 13, wherein a vertical cross-sectional view of the protrusion resembles an arc.

19. The reset button structure according to claim 13, wherein the movement path is substantially equal to 1 mm.

20. The reset button structure according to claim 13, wherein when the body is located in the positioning hole, a gap between the body and the sheath has a width less than a thickness of the protrusion.

21. The reset button structure according to claim 13, wherein when the body is located in the positioning hole, a gap between the body and the sheath has a width between substantially 0.2 mm and substantially 0.3 mm.

22. The reset button structure according to claim 13, wherein the surface of the case has an indentation, and the opening of the positioning hole is located in the indentation.

23. The reset button structure according to claim 13, wherein the positioning hole comprises a first hole and a second hole connecting with each other, a diameter of the first hole is greater than a diameter of the second hole, the body is located in the first hole, and the head is located in the second hole.
